(19) United States
(12) Patent Application Publication
(10) Pub. No.: US 2026/0001352 A1
(43) Pub. Date: Jan. 1, 2026

(54) COATING DEVICE AND IMAGE FORMING SYSTEM

(71) Applicants: Hiroki ISHIHARA, Kanagawa (JP); Kenji NOZAWA, Kanagawa (JP); Hirotaka KOBAYASHI, Kanagawa (JP); Hidetoshi MIGITA, Kanagawa (JP); Kanta FURUYA, Tokyo (JP)

(72) Inventors: Hiroki ISHIHARA, Kanagawa (JP); Kenji NOZAWA, Kanagawa (JP); Hirotaka KOBAYASHI, Kanagawa (JP); Hidetoshi MIGITA, Kanagawa (JP); Kanta FURUYA, Tokyo (JP)

(21) Appl. No.: 19/243,894

(22) Filed: Jun. 20, 2025

(30) Foreign Application Priority Data
Jun. 26, 2024 (JP) 2024-102989

(51) Int. Cl. B41J 11/00

(52) U.S. Cl. CPC B41J 11/0015

(57) ABSTRACT

A coating device includes a reservoir to store a coating liquid, a coating roller to coat a sheet with the coating liquid, a pressure roller to contact the coating roller, a separator to bring and separate the pressure roller into contact with and from the coating roller, a supply unit to supply the coating liquid to the reservoir, a drain unit to drain the coating liquid from the reservoir, a liquid level detector to detect that a liquid level of the coating liquid is below a non-supply position, and circuitry. The circuitry controls the drain unit to drain the coating liquid after a power-off of the coating device, controls the separator to bring the pressure roller into contact with the coating roller after a detection of the liquid level below the non-supply position, and rotate the pressure roller and the coating roller for a predetermined time as an idle rotation.

### CROSS-REFERENCE TO RELATED APPLICATION

This patent application is based on and claims priority pursuant to 35 U.S.C. § 119(a) to Japanese Patent Application No. 2024-102989, filed on Jun. 26, 2024, in the Japan Patent Office, the entire disclosure of which is hereby incorporated by reference herein.

### BACKGROUND

### Technical Field

The present disclosure relates to a coating device that coats an object to be coated, such as a sheet, with a coating liquid, and an image forming system including the coating device and an image forming device.

### Related Art

In the related art, an image forming system includes an image forming device such as an inkjet printer. The image forming system may further include a coating device that coats an object to be coated, such as a sheet, with a coating liquid.

### SUMMARY

The present disclosure described herein provides an improved coating device including a reservoir to store a coating liquid, a coating roller to coat a sheet with the coating liquid supplied from the reservoir as a coating operation, a pressure roller to contact the coating roller to form a nip between the coating roller and the pressure roller to nip and convey the sheet, a separator to bring the pressure roller into contact with the coating roller and separate the pressure roller from the coating roller, a supply unit to supply the coating liquid to the reservoir, a drain unit to drain the coating liquid from the reservoir, a liquid level detector to detect that a liquid level of the coating liquid in the reservoir is below a non-supply position at which the coating liquid is not supplied to the coating roller, and circuitry. The circuitry controls the drain unit to drain the coating liquid from the reservoir after a power-off of the coating device, controls the separator to bring the pressure roller into contact with the coating roller to form the nip after a detection of the liquid level below the non-supply position by the liquid level detector, and rotate the pressure roller and the coating roller for a predetermined time while the pressure roller and the coating roller form the nip as an idle rotation.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming system;

FIG. 2 is a diagram illustrating a configuration of a part of an image forming device;

FIG. 3 is a schematic diagram illustrating a supply path and a drain path of a coating liquid to a reservoir in a coating device;

FIG. 4 is a diagram illustrating a configuration of a part of a coating device;

FIGS. 5A and 5B are diagrams illustrating an operation of a part of a coating device when a power supply is on;

FIGS. 6A and 6B are diagrams illustrating an operation of a part of a coating device when a power supply is turned off,

FIG. 7A is a schematic diagram of a pressure roller and a coating roller left in a non-pressurized state;

FIG. 7B is a schematic diagram of a pressure roller and a coating roller left in a pressurized state;

FIG. 8 is a flowchart of control performed in a coating device; and

FIGS. 9A and 9B are diagrams illustrating an operation of a part of a coating device when a power supply is turned off, according to a modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below in detail with reference to the drawings. In the drawings, like reference signs denote like elements, and overlapping descriptions may be simplified or omitted as appropriate.

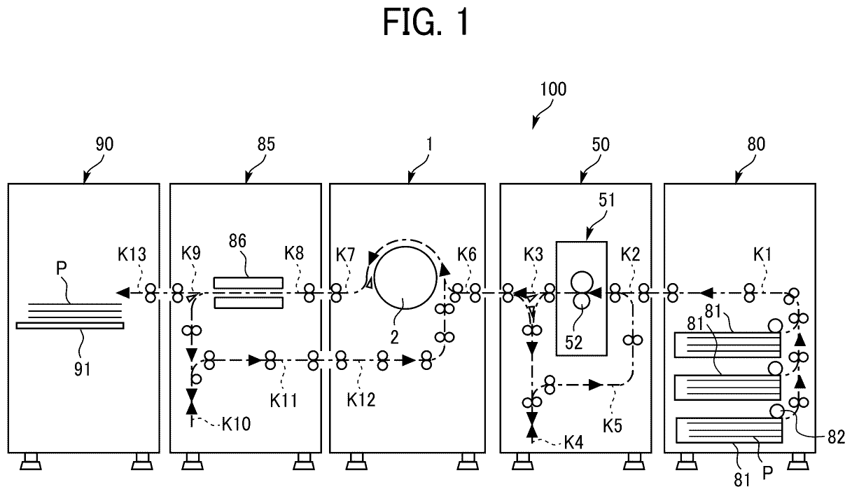

An overall configuration and operation of an image forming system 100 are described below with reference to FIG. 1. As illustrated in FIG. 1, the image forming system 100 includes an image forming device 1 such as an inkjet printer, a coating device 50 to coat a sheet P to be conveyed to the image forming device 1 with a coating liquid as pretreatment, a sheet feeding device 80 to feed the sheet P such as a sheet of paper, a drying device 85 to dry ink on the sheet P after image formation, and a sheet ejection device 90 to stack the sheet P ejected from the drying device 85. As illustrated in FIG. 1, in the image forming system 100, the sheet feeding device 80, the coating device 50, the image forming device 1, the drying device 85, and the sheet ejection device 90 are connected in this order from the upstream side.

With reference to FIG. 1, the operation of the image forming system 100 is briefly described. In response to inputting a print command together with image data from, for example, a personal computer to a controller of the image forming system 100, a feed roller 82 feeds the sheet P from a sheet tray 81. The sheet P fed from the sheet tray 81 is conveyed by conveyance roller pairs toward the coating device 50 via a first conveyance path K1. As illustrated in FIG. 1, the sheet feeding device 80 feeds cut sheets stored in the sheet tray 81, but may feed a rolled sheet.

The sheet P, as an object to be coated, conveyed to the coating device 50 is conveyed to a coating unit 51 via a second conveyance path K2. The coating unit 51 applies the coating liquid as a pretreatment liquid to the lower face of the sheet P, which is a front face during image formation, to reduce bleeding and bleed-through. Such an operation is referred to as a coating process or a coating operation. The sheet P to which the coating liquid is applied is conveyed to a reverse path K4 (fourth conveyance path). The conveyance direction of the sheet P is reversed in the reverse path K4, and then the sheet P is conveyed to the image forming device 1 via a third conveyance path K3 with the front face, onto which the coating liquid has been applied, facing upward.

When a duplex print mode is selected to form images on both faces of the sheet P in the image forming device 1, the coating liquid is applied to both faces of the sheet P. Specifically, the sheet P having one face coated with the coating liquid is conveyed to the reverse path K4, and the conveyance direction of the sheet P is reversed in the reverse path K4. Then, the sheet P is conveyed to a double-sided path K5 (fifth conveyance path) and conveyed to the coating unit 51 again. The coating unit 51 applies the coating liquid to the other face of the sheet P, and the sheet P is conveyed to the image forming device 1 via the third conveyance path K3. The configuration and operation of the coating unit 51 in the coating device 50 will be described in detail later with reference to FIGS. 3 to 8.

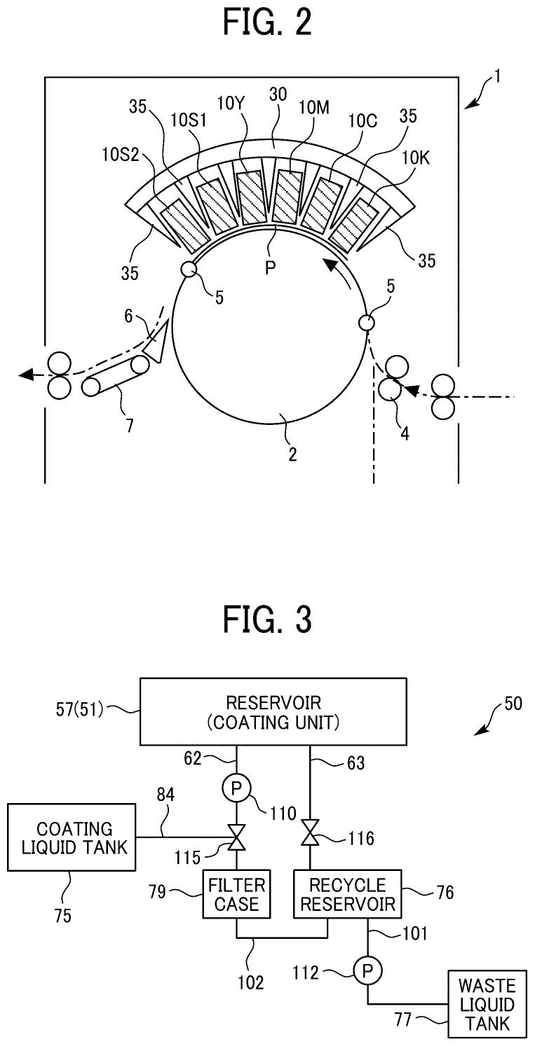

The sheet P conveyed to the image forming device 1 passes through a sixth conveyance path K6, and then a desired image is formed on the front face (upper face) of the sheet P while the sheet P is conveyed by a conveyance drum 2. At this time, the coating liquid applied to the front face of the sheet P as the pretreatment prevents the bleeding and the bleed-through of the image. The sheet P on which the image has been formed is conveyed to the drying device 85 via a seventh conveyance path K7. The configuration and operation of the image forming device 1 will be described in detail later with reference to FIG. 2.

The sheet P conveyed to the drying device 85 is conveyed to a dryer unit 86 via an eighth conveyance path K8 to dry the image on the sheet P. Then, the sheet P on which the image is dried is conveyed to the sheet ejection device 90 via a ninth conveyance path K9.

When the duplex print mode described above is selected, images are formed on both faces of the sheet P. Specifically, the sheet P having one face on which the formed image has been dried is conveyed to a reverse path K10 (tenth conveyance path), and the conveyance direction of the sheet P is reversed in the reverse path K10. Then, the sheet P is conveyed to double-sided paths K11 and K12 (eleventh and twelfth conveyance paths) and conveyed to the conveyance drum 2 of the image forming device 1 again. A desired image is formed on the other face of the sheet P on the conveyance drum 2, and then the sheet P is conveyed to the drying device 85 again via the seventh conveyance path K7. The dryer unit 86 dries the image on the other face of the sheet P, and the sheet P is conveyed to the sheet ejection device 90 via the ninth conveyance path K9.

The sheet P conveyed to the sheet ejection device 90 is stacked on an output tray 91 via a thirteenth conveyance path K13. Thus, a series of operations in the image forming system 100 is completed.

The image forming device 1 (inkjet printer) will be described below in detail with reference to FIG. 2. As illustrated in FIG. 2, the image forming device 1 includes the conveyance drum 2 to convey the sheet P, a gripper 5 to grip the sheet P on the conveyance drum 2, a separator 6 to separate the sheet P from the conveyance drum 2, and a conveyance belt 7 to convey the sheet P separated from the conveyance drum 2. The image forming device 1 further includes heads 10Y, 10M, 10C, 10K, 10S1, and 10S2 (printing modules) serving as image forming units for printing, for example, letters and images by an inkjet method, and a base frame 30 to hold beams 35.

The image forming device 1 forms a color image. As illustrated in FIG. 2, the image forming device 1 includes the head 10K for black, the heads 10Y, 10M, and 10C for three colors (yellow, magenta, and cyan), and the heads 10S1 and 10S2 for coating (two spot colors). The six heads 10Y, 10M, 10C, 10K, 10S1, and 10S2 are opposed to the conveyance drum 2 via small gaps and radially arranged side by side along the direction of rotation of the conveyance drum 2.

The six heads 10Y, 10M, 10C, 10K, 10S1, and 10S2 have substantially the same configuration except that the colors (types) of ink used for printing are different. Each of the heads 10Y, 10M, 10C, 10K, 10S1, and 10S2 is a unit having a substantially rectangular parallelepiped shape. The unit includes a piezoelectric actuator and further includes a nozzle to discharge ink as a liquid (liquid droplets), an ink tank filled with ink, and a control board (controller).

The operation of the image forming device 1 is briefly described with reference to FIG. 2. When the sheet P is conveyed into the image forming device 1, the sheet P is conveyed toward the conveyance drum 2 by a conveyance roller pair 4. Meanwhile, in the heads 10Y, 10M, 10C, 10K, 10S1, and 10S2 for the respective colors, the input image data are converted into writing data of the respective colors. The sheet P conveyed to the conveyance drum 2 is gripped by the gripper 5 and positioned on the conveyance drum 2. The conveyance drum 2 conveys the sheet P while rotating counterclockwise.

As the conveyance drum 2 rotates, the sheet P is conveyed in the direction indicated by the arrow in FIG. 2. The heads 10Y, 10M, 10C, 10K, 10S1, and 10S2 sequentially discharge inks of the respective colors as a liquid onto the sheet P based on the writing data. Thus, a desired image is formed on the sheet P. The sheet P, on which the desired image has been formed, is separated from the conveyance drum 2 by the separator 6. The sheet P separated from the conveyance drum 2 is conveyed by the conveyance belt 7 and conveyed to the drying device 85 by a conveyance roller pair.

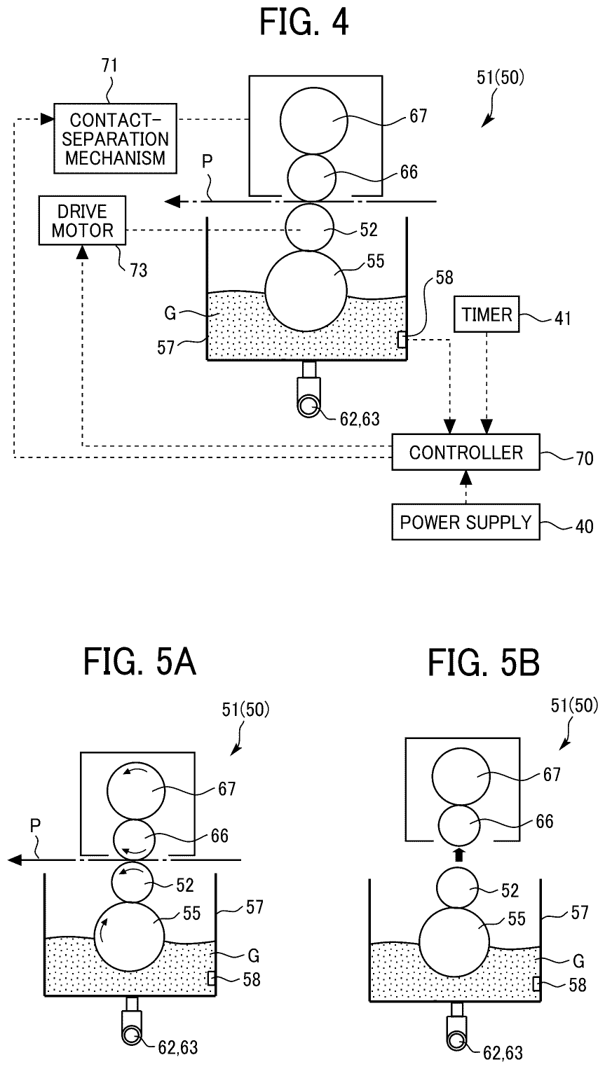

The coating device 50 in the image forming system 100 will be described below in detail with reference to FIGS. 3 to 8. The coating device 50 coats the sheet P as an object to be coated with a coating liquid G. As illustrated in FIG. 4, the coating unit 51 of the coating device 50 includes a reservoir 57 to store the coating liquid G, a coating roller 52, a draw-up roller 55, a pressure roller 66, a pressing roller 67, a liquid level detection sensor 58 as a liquid level detector, a supply pipe 62, and a drain pipe 63.

With reference to FIG. 3, the coating unit 51 of the coating device 50 includes the reservoir 57, a coating liquid tank 75, a recycle reservoir 76 (reserve tank), a waste liquid tank 77, and a filter case 79. The reservoir 57 is connected to the coating liquid tank 75 storing a new coating liquid G via the supply pipe 62 and a coating liquid supply pipe 84.

When the coating liquid G is supplied to the reservoir 57 for the first time, a pump 110 is operated, and a three way valve 115 is switched to fill the reservoir 57 with the coating liquid G supplied from the coating liquid tank 75 through the coating liquid supply pipe 84 and the supply pipe 62. When the reservoir 57 is filled up to a predetermined position with the coating liquid G, the pump 110 is stopped to suspend the supply of the coating liquid G.

During a printing operation (during the coating process), fresh coating liquid G is supplied from the coating liquid tank 75 to the reservoir 57 as appropriate as the coating liquid G in the reservoir 57 is consumed. Further, when a part or all of the coating liquid G in the reservoir 57 is replaced with a new one, the part or all of the coating liquid G is drained from the reservoir 57, and fresh coating liquid G is supplied from the coating liquid tank 75 to the reservoir 57 as appropriate.

As described above, the coating liquid tank 75, the supply pipe 62, the coating liquid supply pipe 84, the pump 110, and the three way valve 115 function as a coating liquid supply unit that supplies the coating liquid G to the reservoir 57. The coating liquid supply unit may be referred to simply as a supply unit.

The reservoir 57 is connected to the recycle reservoir 76 (reserve tank) via the drain pipe 63. The recycle reservoir 76 is connected to the reservoir 57 via a recycle pipe 102, the filter case 79, and the supply pipe 62.

After the printing operation, when a certain period has elapsed without performing the coating process, or when the power supply of the coating device 50 (image forming system 100) is turned off, an electromagnetic valve 116 is opened, and the coating liquid G in the reservoir 57 is fed to the recycle reservoir 76 via the drain pipe 63 by the difference in height to store the coating liquid G in the recycle reservoir 76.

As described above, the recycle reservoir 76, the electromagnetic valve 116, and the drain pipe 63 function as a coating liquid drain unit that drains the coating liquid G from the reservoir 57. The coating liquid drain unit may be referred to simply as a drain unit.

When the next printing operation is started, the pump 110 is operated, and the three way valve 115 is switched to supply the coating liquid G from the recycle reservoir 76 to the reservoir 57 via the recycle pipe 102, the filter case 79, and the supply pipe 62. The filter case 79 has a function of removing impurities mixed in the coating liquid G to be recycled.

As described above, the recycle reservoir 76, the pump 110, the three way valve 115, the recycle pipe 102, the filter case 79, and the supply pipe 62 function as a coating liquid recycle supply unit that supplies the coating liquid G, which is drained by the coating liquid drain unit and stored in the recycle reservoir 76, to the reservoir 57 again. The coating liquid recycle supply unit may be referred to simply as a recycle supply unit.

When the amount of the coating liquid G supplied from the recycle reservoir 76 to the reservoir 57 is not sufficient, the coating liquid G is supplied from the coating liquid tank 75 to the reservoir 57 by an amount corresponding to the shortage.

The recycle reservoir 76 is connected to the waste liquid tank 77 via a waste liquid pipe 101. The recycle reservoir 76 stores the coating liquid G until a predetermined time elapses, but when the coating process is not performed even after the predetermined time elapses, a pump 112 is operated to feed the coating liquid G in the recycle reservoir 76 to the waste liquid tank 77 through the waste liquid pipe 101. Such control is performed because the coating liquid G stored in the recycle reservoir 76 deteriorates with time and is not suitable for use as the coating liquid G.

As illustrated in FIG. 4, a certain amount of the coating liquid G is stored in the reservoir 57 of the coating device 50 (coating unit 51). The reservoir 57 is a substantially rectangular box-shaped component. The reservoir 57 extends in a longitudinal direction, which is a direction orthogonal to the surface of the paper on which FIG. 4 is drawn.

The draw-up roller 55 as a draw-up member extends in the longitudinal direction (the direction orthogonal to the surface of the paper on which FIG. 4 is drawn and the direction of the rotation axis of the draw-up roller 55). The draw-up roller 55 functions as a draw-up member that draws up the coating liquid G stored in the reservoir 57.

The draw-up roller 55 carries the coating liquid G in the reservoir 57 while rotating in the clockwise direction in FIG. 4. The coating liquid G carried on the draw-up roller 55 is adjusted to an appropriate amount at a position where the draw-up roller 55 contacts the coating roller 52 rotating in the counterclockwise direction in FIG. 4, and the coating liquid G adjusted to the appropriate amount is carried on the coating roller 52.

Then, the coating liquid G carried on the coating roller 52 is applied to the surface (lower face) of the sheet P conveyed through the nip between the coating roller 52 and the pressure roller 66 (i.e., the coating process). At this time, the pressure roller 66 rotates in the clockwise direction in FIG. 4 while being pressed by the pressing roller 67 rotating in the counterclockwise direction in FIG. 4.

The draw-up roller 55 extends in the longitudinal direction in substantially the entire region of the reservoir 57. The coating roller 52, the pressure roller 66, and the pressing roller 67 extend in the longitudinal direction in substantially the same range. The sheet P of the maximum size usable in the coating device 50 is conveyed within this range in the longitudinal direction.

The coating roller 52, the draw-up roller 55, the pressure roller 66, and the pressing roller 67 are rotated in predetermined directions by a driving force transmitted from a drive motor 73 via a gear train.

The pressure roller 66 and the pressing roller 67 are unitized and integrally movable as a pressure unit in the vertical direction in FIG. 4 by a contact-separation mechanism 71 (e.g., a cam mechanism) as a contact-separation unit coupled to the pressure unit including the pressure roller 66 and the pressing roller 67. When the coating process is performed, the pressure roller 66 is moved to a contact position (position where the pressure roller 66 contacts the coating roller 52) illustrated in FIGS. 4 and 5A by the contact-separation mechanism 71. On the other hand, when the coating process is not performed, the pressure roller 66 is moved to a separation position (position separated from the coating roller 52) illustrated in FIG. 5B together with the pressing roller 67 by the contact-separation mechanism 71.

Multiple pipes (the supply pipe 62 and the drain pipe 63) are connected to the bottom of the reservoir 57. The supply pipe 62 and the drain pipe 63 function as described above with reference to FIG. 3.

As described above, the draw-up roller 55 draws up the coating liquid G stored in the reservoir 57 and directly supplies the coating liquid G to the coating roller 52. The coating roller 52 applies the coating liquid G, which is indirectly supplied from the reservoir 57 via the draw-up roller 55, to the sheet P. The pressure roller 66 contacts the coating roller 52 to form the nip therebetween to nip and convey the sheet P together with the coating roller 52. The contact-separation mechanism 71 functions as a contact-separation unit that moves the pressure roller 66 relative to the coating roller 52 to bring the pressure roller 66 into contact with the coating roller 52 and separate the pressure roller 66 from the coating roller 52.

With reference to FIGS. 4 to 6B, the coating device 50 (coating unit 51) includes the liquid level detection sensor 58 as a liquid level detector. The liquid level detection sensor 58 detects that the liquid level (water level) of the coating liquid G stored in the reservoir 57 falls below a non-supply position. The coating liquid G below the non-supply position is not supplied to the coating roller 52 by the draw-up roller 55.

Specifically, as the liquid level detection sensor 58 (liquid level detector), for example, a reflective photosensor can be used to optically detect whether the coating liquid G is present at the “non-supply position.” The “non-supply position” is a position of the liquid surface of the coating liquid G, where the draw-up roller 55 does not contact, remaining in the reservoir 57. In other words, the draw-up roller 55 has a lower end above the non-supply position.

More specifically, when the liquid level of the coating liquid G reaches the lower end of the draw-up roller 55 and the coating liquid G is not supplied to the coating roller 52 via the draw-up roller 55, the liquid level detection sensor 58 detects that the liquid level of the coating liquid G stored in the reservoir 57 reaches the “non-supply position.” The liquid level detection sensor 58 detects that the liquid level of the coating liquid G reaches the non-supply position by a change in an electrical signal when the liquid level of the coating liquid G is displaced from a position above the non-supply position to a position below the non-supply position.

With reference to FIGS. 4 to 6B, when a power supply 40 of the coating device 50 (also serving as the power supply of the image forming system 100) is about to be turned off (i.e., during a power-off operation), the coating liquid drain unit including the drain pipe 63, the recycle reservoir 76, and the electromagnetic valve 116 (see FIG. 3) starts draining the coating liquid G from the reservoir 57. When the liquid level detection sensor 58 (liquid level detector) detects that the liquid level of the coating liquid G remaining in the reservoir 57 has reached the non-supply position, the coating roller 52 and the pressure roller 66 rotate at idle (i.e., an idle rotation) for a predetermined time Tx while the contact-separation mechanism 71 (contact-separation unit) brings the pressure roller 66 into contact with the coating roller 52. The predetermined time Tx is a first predetermined time, which may be about 10 seconds.

In other words, when the liquid level detection sensor 58 detects that the liquid level of the coating liquid G has reached the non-supply position, the coating roller 52 and the pressure roller 66 rotate idly for the predetermined time Tx (first predetermined time) in a state where the pressure roller 66 is brought into contact with the coating roller 52 by the contact-separation mechanism 71.

After the idle rotation for the predetermined time Tx (first predetermined time) is finished, the contact-separation mechanism 71 (contact-separation unit) separates the pressure roller 66 from the coating roller 52. After that, the power supply 40 of the coating device 50 is completely powered off. In other words, the above-described operation including the idle rotation is performed from the power-off of the coating device 50 (i.e., from when the power-off operation starts) to when the coating device 50 is completely powered off.

The “idle rotation” of the coating roller 52 and the pressure roller 66 is defined as the rotation (rotational driving) of the coating roller 52 and the pressure roller 66 without applying the coating liquid G to the sheet P while conveying the sheet P (i.e., without the coating process).

Specifically, when the power is on (when the power supply 40 is on) and the coating process is performed on the sheet P (when the sheet P is conveyed), as illustrated in FIG. 5A, a controller 70 as circuitry controls the contact-separation mechanism 71 to lower the pressure unit holding the pressure roller 66 and the pressing roller 67 to bring the pressure roller 66 in contact with the coating roller 52 to form the nip between the coating roller 52 and the pressure roller 66. The controller 70 controls the draw-up roller 55, the coating roller 52, the pressure roller 66, and the pressing roller 67 to rotate in the directions indicated by the arrows illustrated in FIG. 5A by the driving of the drive motor 73 to apply the coating liquid G to the sheet P conveyed through the nip between the coating roller 52 and the pressure roller 66.

When the power is on and the sheet P is not subjected to the coating process (when no sheet is conveyed), as illustrated in FIG. 5B, the controller 70 controls the contact-separation mechanism 71 to raise the pressure unit holding the pressure roller 66 and the pressing roller 67 to separate the pressure roller 66 from the coating roller 52 to release the nip. At this time, the drive motor 73 stops driving the respective rollers such as the coating roller 52.

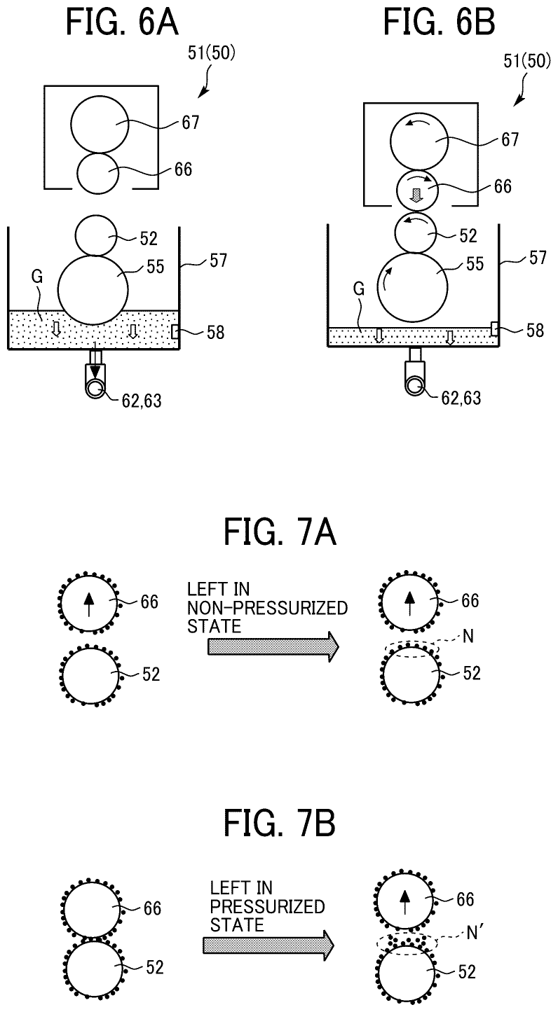

When the power supply 40 is about to be turned off, the controller 70 opens the electromagnetic valve 116 (see FIG. 3), and the coating liquid G in the reservoir 57 is drained toward the recycle reservoir 76 through the drain pipe 63 in the power-off operation, as illustrated in FIG. 6A.

As illustrated in FIG. 6B, when the liquid level detection sensor 58 detects that the liquid level (water level) of the coating liquid G in the reservoir 57 has lowered to the non-supply position as the coating liquid G is drained through the drain pipe 63, the controller 70 grasps the state and controls the contact-separation mechanism 71 to lower the pressure unit holding the pressure roller 66 and the pressing roller 67 to bring the pressure roller 66 into contact with the coating roller 52 to form the nip between the coating roller 52 and the pressure roller 66. The controller 70 controls the drive motor 73 to drive the coating roller 52 and the pressure roller 66 (and the draw-up roller 55 and the pressing roller 67) to rotate at idle in the directions indicated by the arrows in FIG. 6B (i.e., the idle rotation).

Accordingly, the coating liquid G carried on the coating roller 52 and the pressure roller 66 (and the draw-up roller 55 and the pressing roller 67) is squeezed out with the contact pressure applied between the rollers to reduce the amount of the coating liquid G carried on the respective rollers, in particular, on the coating roller 52.

When the idle rotation is finished, lastly, the controller 70 controls the contact-separation mechanism 71 to raise the pressure unit holding the pressure roller 66 and the pressing roller 67 to separate the pressure roller 66 from the coating roller 52 to release the nip. Further, the drive motor 73 stops driving the respective rollers such as the coating roller 52.

When the coating device 50 is about to be powered off, for example, the above-described operation (i.e., the power-off operation) is performed after a switch for power-off is operated, and the power supply 40 is completely turned off after the above-described operation is finished. Alternatively, an auxiliary power source installed in the coating device 50 (or in the image forming system 100) may supply power for the above-described operation after the power supply 40 is turned off.

As described above, when the liquid level detection sensor 58 detects that the liquid level of the coating liquid G in the reservoir 57 has fallen to the non-supply position while the coating liquid G is drained from the reservoir 57 during the power-off operation, the coating roller 52 and the pressure roller 66 in contact with the coating roller 52 rotate at idle for the predetermined time Tx (first predetermined time), and thus the coating liquid G adhering to the coating roller 52 is less likely to be fixed on the coating roller 52.

Specifically, when the coating liquid G is drained from the reservoir 57 during the power-off operation, if the coating roller 52 and the pressure roller 66 are separated from each other or if the coating roller 52 and the pressure roller 66 in contact with each other do not rotate, a relatively large amount of the coating liquid G remains adhering to the coating roller 52, and the coating liquid G adhering to the coating roller 52 may be eventually fixed onto the coating roller 52. If the coating process is performed on the next sheet P by the coating roller 52 onto which the coating liquid G is fixed, the amount of the coating liquid G applied to the sheet P may vary, or the quality of the image formed on the sheet P may deteriorate.

In contrast, in the present embodiment, the coating liquid G is drained from the reservoir 57 during the power-off operation. When the liquid level detection sensor 58 detects that the liquid level of the coating liquid G in the reservoir 57 has fallen to the non-supply position, i.e., when the coating liquid G is not newly supplied to the coating roller 52, the coating roller 52 and the pressure roller 66 in contact with the coating roller 52 rotate at idle. Thus, the coating liquid G adhering to the coating roller 52 is squeezed out. As a result, the amount of the coating liquid G adhering to the coating roller 52 is reduced, and the coating liquid G adhering to the coating roller 52 is less likely to be fixed onto the coating roller 52.

In the present embodiment, after the idle rotation of the coating roller 52 and the pressure roller 66 in contact with the coating roller 52 (i.e., a contact state) during the power-off operation as described above is finished (after the coating liquid G adhering to the coating roller 52 is squeezed out), the pressure roller 66 is separated from the coating roller 52 (i.e., a non-contact state or separated state). As a result, the coating liquid G is less likely to locally adhere onto the coating roller 52.

Specifically, as illustrated in FIG. 7B, after the idle rotation in the contact state between the coating roller 52 and the pressure roller 66 during the power-off operation is finished, if the coating roller 52 and the pressure roller 66 are left in the contact state (pressurized state), the coating liquid G adhering to a nip N′ is likely to be fixed, and thus the coating liquid G may unevenly adhere onto the coating roller 52 although the coating liquid G adhering to the coating roller 52 is squeezed out to some extent. In this state, when the coating process is performed on the next sheet P, the above-described variation in the amount of the coating liquid G and the deterioration in the image quality are likely to occur.

In contrast, in the present embodiment, as illustrated in FIG. 7A, after the idle rotation in the contact state between the coating roller 52 and the pressure roller 66 during the power-off operation is finished, the coating roller 52 and the pressure roller 66 are left in the non-contact state (separated state or non-pressurized state). As a result, the coating liquid G adhering to a nip N is less likely to be fixed, and the coating liquid G adheres substantially evenly onto the coating roller 52. Accordingly, even when the coating process is performed on the next sheet P, the variation in the amount of the coating liquid G and the deterioration in the image quality are less likely to occur.

In the present embodiment, when a timer 41 (see FIG. 4) as a liquid deterioration detector detects the deterioration of the coating liquid G stored in the reservoir 57, the coating liquid supply unit including the supply pipe 62, the coating liquid tank 75, the coating liquid supply pipe 84, the pump 110, and the three way valve 115 supplies the coating liquid G to the reservoir 57, and the coating roller 52 and the pressure roller 66 rotate at idle for a second predetermined time Tw (predetermined time) while the contact-separation mechanism 71 (contact-separation unit) brings the pressure roller 66 into contact with the coating roller 52.

The timer 41 functions as the liquid deterioration detector to detect that the coating liquid G stored in the reservoir 57 has deteriorated. The timer 41 measures the time (off period) during which the coating operation of the coating device 50 (image forming system 100) is stopped while the power supply 40. When the off period (may be referred to as a stopped period) reaches a first predetermined value (predetermined value, e.g., a predetermined number of days W), the timer 41 detects that the coating liquid G has deteriorated.

Specifically, when the operation of the coating device 50 (image forming system 100) is stopped while the power supply 40 is on, the timer 41 measures the time (the number of days elapsed in the off period) from when the operation is stopped. When the time (the number of days elapsed in the off period) measured by the timer 41 reaches the predetermined number of days W, the timer 41 determines that the coating liquid G stored in the reservoir 57 has deteriorated due to long-term non-use, and a new coating liquid G is supplied from the coating liquid tank 75 to the reservoir 57.

Then, in the reservoir 57 to which the new coating liquid G is supplied, the coating roller 52 and the pressure roller 66 (and the draw-up roller 55 and the pressing roller 67) rotate in the contact state.

Lastly, the used coating liquid G (the coating liquid G in the reservoir 57) is drained through the drain pipe 63. In other words, after the idle rotation for the second predetermined time Tw is finished, the contact-separation mechanism 71 (contact-separation unit) separates the pressure roller 66 from the coating roller 52, and the coating liquid drain unit including the drain pipe 63, the recycle reservoir 76, and the electromagnetic valve 116 drains the coating liquid G from the reservoir 57.

The above operation is performed when the power supply 40 is on. Thus, the deteriorated coating liquid G adhering to the rollers such as the coating roller 52 is removed even when the power supply 40 is on. Since a new coating liquid G is carried on the rollers in the next coating process, the next coating process is performed satisfactorily. Further, since the deteriorated coating liquid G is drained from the reservoir 57, the effect thereof is further achieved.

In the above description, the timer 41 (liquid deterioration detector) detects the deterioration of the coating liquid G in the reservoir 57 when the power supply 40 is on, and then the new coating liquid G is supplied from the coating liquid tank 75 to the reservoir 57, but the coating liquid G to be recycled may be supplied from the recycle reservoir 76 to the reservoir 57.

Specifically, the operation of the coating device 50 (image forming system 100) is stopped while the power supply 40 is on, and the timer 41 (see FIG. 4) as the liquid deterioration detector detects the deterioration of the coating liquid G stored in the reservoir 57. Then, the coating liquid recycle supply unit including the supply pipe 62, the recycle reservoir 76, the filter case 79, the recycle pipe 102, the pump 110, and the three way valve 115 may supply the coating liquid G to the reservoir 57, and the coating roller 52 and the pressure roller 66 may rotate at idle for the second predetermined time Tw while the contact-separation mechanism 71 (contact-separation unit, which may be referred to as a separator) brings the pressure roller 66 into contact with the coating roller 52. The coating liquid recycle supply unit stores the coating liquid G drained by the coating liquid drain unit including the drain pipe 63, the recycle reservoir 76, and the electromagnetic valve 116 in the recycle reservoir 76 and supplies the coating liquid G in the recycle reservoir 76 to the reservoir 57 again.

In the above description, the timer 41 as the liquid deterioration detector detects that the coating liquid G stored in the reservoir 57 has deteriorated when the time during which the operation of the coating device 50 is stopped while the power supply 40 is on reaches the first predetermined value (predetermined value).

Alternatively, the timer 41 as the liquid deterioration detector may detect that the coating liquid G stored in the reservoir 57 has deteriorated when an operation period during which the coating operation of the coating device 50 is performed, until the coating operation is stopped while the power supply 40 is on reaches a second predetermined value (predetermined value). The operation period may be a total operation period which is sum of operation periods during each of which the coating operation of the coating device 50 is performed, or may be a period during which the coating operation of the coating device 50 is continuously performed. The total operation period includes the operation periods of the coating operations intermittently performed.

Similarly to when the power supply 40 is on, even when the power supply 40 is off, the liquid deterioration detector detects the deterioration of the coating liquid G stored in the reservoir 57, and then the coating liquid supply unit including the supply pipe 62, the coating liquid tank 75, the coating liquid supply pipe 84, the pump 110, and the three way valve 115 may supply the coating liquid G to the reservoir 57. After that, the coating roller 52 and the pressure roller 66 may rotate at idle for the second predetermined time Tw while the contact-separation mechanism 71 (contact-separation unit) brings the pressure roller 66 into contact with the coating roller 52. Such an operation may be powered by an auxiliary power source installed in the coating device 50 (or in the image forming system 100).

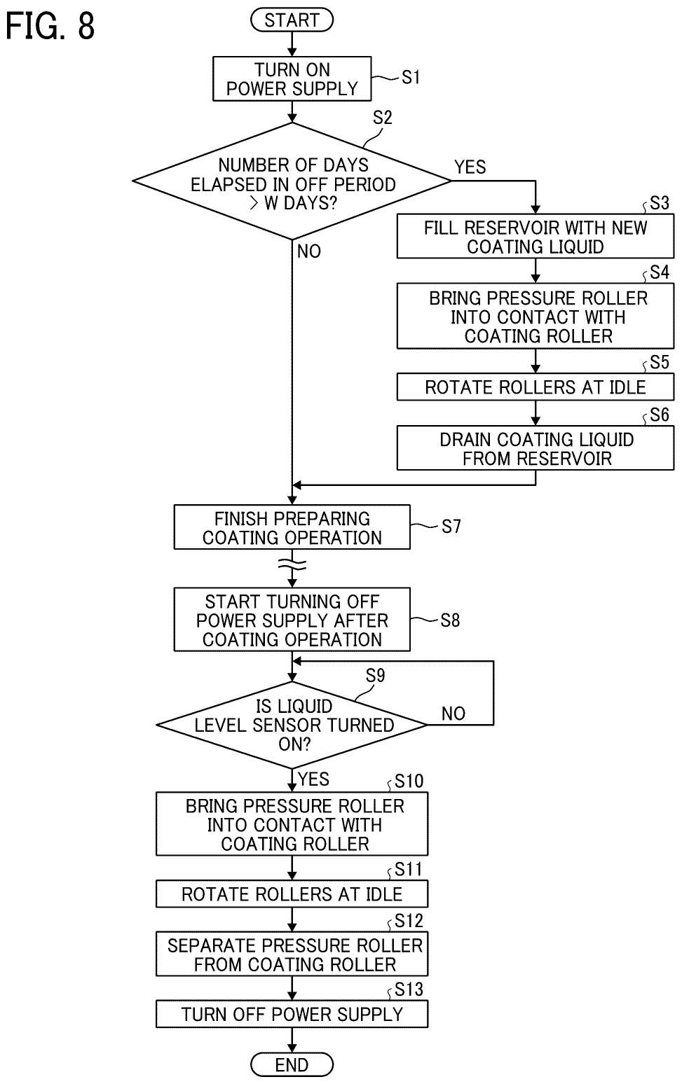

Control performed by the coating device 50 described above will be described below with reference to a flowchart of FIG. 8. As illustrated in FIG. 8, in step S1, the power supply 40 is turned on. In step S2, the timer 41 determines whether the time (the number of days elapsed in the off period) during which the operation (e.g., the coating operation) of the coating device 50 is continuously stopped while the power supply 40 is on exceeds W days based on the detection result. As a result, when the number of days elapsed in the off period does not exceed W days, the timer 41 determines that the coating liquid G has not deteriorated, and in step S7, the preparation for a coating operation is finished without performing any special operation.

On the other hand, in step S2, when the number of days elapsed in the off period is W days or more, the timer 41 determines that the coating liquid G has deteriorated, and in step S3, the controller 70 controls the coating liquid supply unit (or the coating liquid recycle supply unit) to supply the coating liquid C to the reservoir 57 so as to filled the reservoir 57 with the new coating liquid G from the coating liquid tank 75. Then, in step S4, the controller 70 controls the contact-separation mechanism 71 to bring the pressure roller 66 into contact with the coating roller 52, and in step S5, the controller 70 controls the drive motor 73 to operate to rotate the rollers such as the coating roller 52 and the pressure roller 66 at idle. After the idle rotation for the second predetermined time Tw, in step S6, the controller 70 controls the coating liquid drain unit to drain the coating liquid G in the reservoir 57 through the drain pipe 63, and in step S7, the preparation for the coating operation is finished. When the coating operation is not performed immediately, the contact-separation mechanism 71 may separate the pressure roller 66 from the coating roller 52 in step S6

When the coating device 50 finishes the coating operation, and in step S8, the power supply 40 is about to be turned off (switched off), the coating liquid G in the reservoir 57 is drained through the drain pipe 63. In step S9, the liquid level detection sensor 58 detects whether the liquid level of the coating liquid G is lowered to the non-supply position (i.e., whether the liquid level detection sensor 58 is turned on). When the liquid level detection sensor 58 is turned on (when the liquid level of the coating liquid G is lowered to the non-supply position), in step S10, the controller 70 controls the contact-separation mechanism 71 to bring the pressure roller 66 into contact with the coating roller 52, and in step S11, the controller 70 controls the drive motor 73 to operate to rotate the rollers such as the coating roller 52 and the pressure roller 66 at idle. After the idle rotation for the predetermined time Tx, in step S12, the controller 70 controls the contact-separation mechanism 71 to separate the pressure roller 66 from the coating roller 52, and in step S13, the power supply 40 is completely turned off.

### Modification

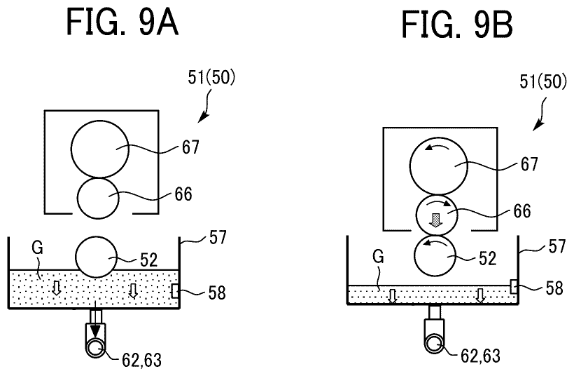

As illustrated in FIGS. 9A and 9B, in the coating device 50 (coating unit 51) according to a modification, the coating roller 52 can directly draw up the coating liquid G stored in the reservoir 57. In other words, the coating device 50 according to the modification does not include the draw-up roller 55 as described with reference to FIGS. 4 to 6B. In the coating device 50 according to the modification, when the liquid level detection sensor 58 detects that the liquid level of the coating liquid G in the reservoir 57 has fallen to the non-supply position while the coating liquid G is drained from the reservoir 57 during the power-off operation, the coating roller 52 and the pressure roller 66 in contact with the coating roller 52 rotate at idle for the predetermined time Tx. The “non-supply position” in this case is a position of the liquid surface of the coating liquid G, where the coating roller 52 does not contact, remaining in the reservoir 57. In the coating device 50 as described above, the coating liquid G adhering to the coating roller 52 is less likely to be fixed.

As described above, the coating device 50 (image forming system 100) includes the reservoir 57 to store the coating liquid G, the coating roller 52 to coat the sheet P with the coating liquid G indirectly or directly supplied from the reservoir 57, and the pressure roller 66 to contact the coating roller 52 to form a nip to nip and convey the sheet P together with the coating roller 52. The coating device 50 further includes the contact-separation mechanism 71 (contact-separation unit) to bring the pressure roller 66 into contact with and separate the pressure roller 66 from the coating roller 52 relatively, the coating liquid supply unit including the supply pipe 62, the coating liquid tank 75, the coating liquid supply pipe 84, the pump 110, and the three way valve 115 to supply the coating liquid G to the reservoir 57, the coating liquid drain unit including the drain pipe 63, the recycle reservoir 76, and the electromagnetic valve 116 to drain the coating liquid G from the reservoir 57, and a liquid level detection sensor 58 (liquid level detector) to detect that the liquid level of the coating liquid G stored in the reservoir 57 falls below a non-supply position at which the coating liquid G is not supplied to the coating roller 52. When the power supply 40 of the coating device 50 is about to be turned off (i.e., during the power-off operation), the coating liquid drain unit including the drain pipe 63, the recycle reservoir 76, and the electromagnetic valve 116 starts draining the coating liquid G from the reservoir 57, and the liquid level detection sensor 58 detects that the liquid level of the coating liquid G remaining in the reservoir 57 has reached the non-supply position. After that, the coating roller 52 and the pressure roller 66 in contact with the coating roller 52 rotate for the predetermined time Tx while the contact-separation mechanism 71 brings the pressure roller 66 into contact with the coating roller 52. Due to such a configuration, the coating liquid G adhering to the coating roller 52 is less likely to be fixed.

One or more rollers for transferring the coating liquid G from the draw-up roller 55 to the coating roller 52 may be interposed between the draw-up roller 55 and the coating roller 52. In this case, the draw-up roller 55 draws up the coating liquid G stored in the reservoir 57 and indirectly supplies the coating liquid G to the coating roller 52. In the present embodiment, the contact-separation mechanism 71 as the contact-separation unit moves the pressure roller 66, but a contact-separation mechanism may move the coating roller 52 or may move both the pressure roller 66 and the coating roller 52. A rectifier plate may be installed between the draw-up roller 55 and the bottom of the reservoir 57.

In the present embodiment, the present disclosure is applied to the coating device 50 as the pretreatment device of the inkjet printer, but the application of the present disclosure is not limited thereto, and the present disclosure can be applied to all coating devices that store the coating liquid. Such a coating device can achieve the same advantages as the advantages of the present embodiment.

The present disclosure is not limited to the above-described embodiment, modifications, and variations, and the configuration of the present embodiment can be appropriately modified other than suggested in the above embodiment, modifications, and variations within a scope of the technological concept of the present disclosure. The number, position, and shape of the components described above are not limited to those embodiments described above. Desirable number, position, and shape can be determined to perform the present disclosure.

Aspects of the present disclosure are, for example, as follows, and Aspects 1 to 8 can be combined.

### Aspect 1

A coating device includes a reservoir to store a coating liquid, a coating roller to coat a sheet with the coating liquid indirectly or directly supplied from the reservoir, and a pressure roller to contact the coating roller to form a nip to nip and convey the sheet together with the coating roller, a contact-separation unit to bring the pressure roller into contact with and separate the pressure roller 66 from the coating roller 52 relatively, a coating liquid supply unit to supply the coating liquid to the reservoir, a coating liquid drain unit to drain the coating liquid from the reservoir, and a liquid level detector to detect that the liquid level of the coating liquid stored in the reservoir falls below a non-supply position at which the coating liquid is not supplied to the coating roller. When a power supply of the coating device is turned off, the coating liquid drain unit starts draining the coating liquid from the reservoir, and the liquid level detection sensor detects that the liquid level of the coating liquid remaining in the reservoir has reached the non-supply position. After that, the coating roller and the pressure roller rotate for a predetermined time while the contact-separation unit brings the pressure roller into contact with the coating roller (i.e., an idle rotation).

In other words, a coating device includes a reservoir to store a coating liquid, a coating roller to coat a sheet with the coating liquid supplied from the reservoir as a coating operation, a pressure roller to contact the coating roller to form a nip between the coating roller and the pressure roller to nip and convey the sheet, a separator to bring the pressure roller into contact with the coating roller and separate the pressure roller from the coating roller, a supply unit to supply the coating liquid to the reservoir, a drain unit to drain the coating liquid from the reservoir, a liquid level detector to detect that a liquid level of the coating liquid in the reservoir is below a non-supply position at which the coating liquid is not supplied to the coating roller, and circuitry. The circuitry controls the drain unit to drain the coating liquid from the reservoir after a power-off of the coating device, controls the separator to bring the pressure roller into contact with the coating roller to form the nip after a detection of the liquid level below the non-supply position by the liquid level detector, and rotate the pressure roller and the coating roller for a predetermined time while the pressure roller and the coating roller form the nip as an idle rotation.

### Aspect 2

In the coating device according to Aspect 1, the coating roller and the pressure roller are separated from each other by the contact-separation unit after the idle rotation for the predetermined time is finished.

In other words, the circuitry controls the separator to separate the pressure roller from the coating roller after performing the idle rotation for the predetermined time.

### Aspect 3

The coating device according to Aspect 1 or 2, further includes a draw-up roller to draw up the coating liquid stored in the reservoir and indirectly or directly supply the coating liquid to the coating roller. The non-supply position is a position of a liquid surface at which the draw-up roller does not contact the coating liquid remaining in the reservoir.

In other words, the coating device according to Aspect 1 or 2, further includes a draw-up roller to draw up the coating liquid in the reservoir and supply the coating liquid to the coating roller. The draw-up roller has a lower end above the non-supply position.

### Aspect 4

In the coating device according to Aspect 1 or 2, the coating roller directly draws up the coating liquid stored in the reservoir. The non-supply position is a position of a liquid surface at which the coating roller does not contact the coating liquid remaining in the reservoir.

In other words, the coating roller has a lower end below the liquid level of the coating liquid in the reservoir when the coating roller coats the sheet with the coating liquid. The coating roller directly draws up the coating liquid in the reservoir. The coating roller has the lower end above the non-supply position.

### Aspect 5

In the coating device according to any one of Aspects 1 to 4, when the deterioration of the coating liquid stored in the reservoir is detected by a liquid deterioration detector, the coating liquid is supplied to the reservoir by the coating liquid supply unit or a coating liquid recycle supply unit that supplies the coating liquid drained by the coating liquid drain unit and stored in a recycle reservoir to the reservoir again. The coating roller and the pressure roller rotate at idle for a second predetermined time in a state of the coating roller and the pressure roller in contact with each other by the contact-separation unit.

In other words, the coating device according to any one of Aspects 1 to 4, further includes a liquid deterioration detector to detect a deterioration of the coating liquid in the reservoir, a recycle reservoir to store the coating liquid drained from the reservoir by the drain unit, and a recycle supply unit to supply the coating liquid in the recycle reservoir to the reservoir, When the liquid deterioration detector detects that the coating liquid in the reservoir has deteriorated, the circuitry controls the supply unit or the recycle supply unit to supply the coating liquid to the reservoir and controls the coating roller and the pressure roller to perform the idle rotation for another predetermined time while the pressure roller and the coating roller form the nip.

### Aspect 6

In the coating device according to Aspect 5, the liquid deterioration detector detects that the coating liquid stored in the reservoir has deteriorated when a time during which an operation of the coating device is stopped while the power supply is on reaches a first predetermined value or when an operation time of the coating device until the operation of the coating device is stopped while the power supply is on reaches a second predetermined value.

In other words, the liquid deterioration detector is a timer to measure a stopped period during which the coating operation is stopped while the coating device is powered on and a total operation period during which the coating operation is performed while the coating device is powered on. The liquid deterioration detector detects that the coating liquid in the reservoir has deteriorated when the stopped period reaches a first predetermined value or when the total operation period reaches a second predetermined value.

### Aspect 7

In the coating device according to Aspect 5 or 6, after the idle rotation for the second predetermined time is finished, the coating roller and the pressure roller are separated from each other by the contact-separation unit, and the coating liquid is drained from the reservoir by the coating liquid drain unit.

In other words, after the coating roller and the pressure roller perform the idle rotation for said another predetermined time, the circuitry controls the separator to separate the pressure roller from the coating roller and controls the drain unit to drain the coating liquid from the reservoir.

### Aspect 8

An image forming system includes the coating device according to any one of Aspects 1 to 7 and an image forming device.

In other words, an image forming system includes the coating device according to any one of Aspects 1 to 7 and an image forming device to form an image on the sheet coated with the coating liquid by the coating device.

As described above, according to one aspect of the present disclosure, a coating device and an image forming system can be provided that prevent the coating liquid adhering to the coating roller from being fixed onto the coating roller.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A coating device comprising:
a reservoir to store a coating liquid;
a coating roller to coat a sheet with the coating liquid supplied from the reservoir as a coating operation;
a pressure roller to contact the coating roller to form a nip between the coating roller and the pressure roller to nip and convey the sheet;
a separator to bring the pressure roller into contact with the coating roller and separate the pressure roller from the coating roller;
a supply unit to supply the coating liquid to the reservoir;
a drain unit to drain the coating liquid from the reservoir;
a liquid level detector to detect that a liquid level of the coating liquid in the reservoir is below a non-supply position at which the coating liquid is not supplied to the coating roller; and
circuitry configured to:
control the drain unit to drain the coating liquid from the reservoir after the liquid level detector detects that the liquid level is below the non-supply position after a power-off of the coating device;
control the separator to bring the pressure roller into contact with the coating roller to form the nip after a detection of the liquid level below the non-supply position by the liquid level detector; and
rotate the pressure roller and the coating roller for a predetermined time while the pressure roller and the coating roller form the nip as an idle rotation.

2. The coating device according to claim 1,
wherein the circuitry is further configured to:
control the separator to separate the pressure roller from the coating roller after performing the idle rotation for the predetermined time.

3. The coating device according to claim 1, further comprising a draw-up roller to draw up the coating liquid in the reservoir and supply the coating liquid to the coating roller,
wherein the draw-up roller has a lower end above the non-supply position.

4. The coating device according to claim 1,
wherein the coating roller has a lower end below the liquid level of the coating liquid in the reservoir when the coating roller coats the sheet with the coating liquid,
the coating roller directly draws up the coating liquid in the reservoir, and
the coating roller has the lower end above the non-supply position.

5. The coating device according to claim 1, further comprising:
a liquid deterioration detector to detect a deterioration of the coating liquid in the reservoir;
a recycle reservoir to store the coating liquid drained from the reservoir by the drain unit; and
a recycle supply unit to supply the coating liquid in the recycle reservoir to the reservoir,
wherein the circuitry is further configured to, when the liquid deterioration detector detects that the coating liquid in the reservoir has deteriorated:
control the supply unit or the recycle supply unit to supply the coating liquid to the reservoir; and
control the coating roller and the pressure roller to perform the idle rotation for another predetermined time while the pressure roller and the coating roller form the nip.

6. The coating device according to claim 5,
wherein the liquid deterioration detector is a timer to measure:
a stopped period during which the coating operation is stopped while the coating device is powered on; and
a total operation period during which the coating operation is performed while the coating device is powered on, and
the liquid deterioration detector detects that the coating liquid in the reservoir has deteriorated:
when the stopped period reaches a first predetermined value; or
when the total operation period reaches a second predetermined value.

7. The coating device according to claim 5,
wherein, after the coating roller and the pressure roller perform the idle rotation for said another predetermined time,
the circuitry is further configured to:
control the separator to separate the pressure roller from the coating roller; and
control the drain unit to drain the coating liquid from the reservoir.

8. An image forming system comprising:
the coating device according to claim 1; and
an image forming device to form an image on the sheet coated with the coating liquid by the coating device.
